(19) United States
(12) Patent Application Publication
(10) Pub. No.: US 2001/0015552 A1
(43) Pub. Date: Aug. 23, 2001

(54) Successively developable book

(76) Inventor: Yasuo Namikoshi, Osaka (JP)

Correspondence Address: FASSE PATENT ATTORNEYS, P.A., P.O. BOX 726, HAMPDEN, ME, 04444-0726, US

(21) Appl. No.: 09/749,134

(22) Filed: Dec. 26, 2000

(30) Foreign Application Priority Data
Feb. 23, 2000 (JP) 2000-045338(P)

(51) Int. Cl. B42D 1/00; B42D 5/00

(52) U.S. Cl. 281/15.1

(57) ABSTRACT

The present successively developable book includes a left page and a right page, which have upper and lower portions provided with upper and lower elongate members, respectively, which sandwich an elongate graphics displaying member. As such, when the left and right pages are rotated and thus spread apart from each other the book can be developed successively.

### BACKGROUND OF THE INVENTION

1. Field of the Invention

The present invention relates to books and particularly to structures of books having right and left pages rotated in a direction allowing such pages to be spread apart from each other to successively develop the same.

2. Description of the Background Art

As a conventional developable form, a rotative table is disclosed in Japanese Utility Model Publication No. 13-16069. This rotative table is formed of a substrate and elongate displaying members of the same width wound around the substrate to eliminate the inconvenience of a laterally elongate time table, statistics table or the like when the table is used.

Furthermore, a conventional book is typically configured of a plurality of pages bound along the back of the book, as with restaurant menus, product catalogues and the like. Furthermore, as other forms of book, Japanese Utility Model Laying-Open No. 53-145535 discloses a multi-plane three-dimensional picture book, Japanese Utility Model Laying-Open No. 53-15855 discloses a successive picture book, registered Japanese Utility Model No. 3035922 discloses a card pad, and Japanese Patent Laying-Open No. 11-180067 discloses an information providing tool.

Japanese Utility Model Laying-Open No. 53-145535 discloses the multi-plane three-dimensional picture book having a page portion developed by 360° to enjoy the picture book three dimensionally. Furthermore, Japanese Utility Model Laying-Open No. 53-15855 discloses the successive picture book having page portions folded alternately in different directions. Furthermore, registered Japanese Utility Model No. 3035922 discloses the card pad having a plurality of cards connected by a band. Furthermore, Japanese Patent Laying-Open No. 11-180067 discloses the information providing tool or the like corresponding to a picture book including a plurality of movable members housed in a case.

Any of the rotative table and books, however, fail to adopt a structure of a book having a center portion presenting a graphical representation of large size, with the pages successively rotated as if they were spread.

### SUMMARY OF THE INVENTION

The present invention contemplates a structure of a book successively developed by rotating and thus spreading left and right pages apart from each other.

The present invention in one aspect provides a successively developable book presenting a different graphical representation for each spread page, including: a first core member provided in a form of a plate and forming a left page; a second core member provided in a form of a plate and forming a right page; an elongate graphics displaying member located at a center region of the book and presenting a graphical representation, unwound from the first core member as the elongate graphics displaying member is wound around the second core member when the left page and the right page are successively rotated and thus spread apart from each other; and an upper elongate member and a lower elongate member provided at upper and lower ends, respectively, of the elongate graphics displaying member and unwound from the second core member as the upper elongate member and the lower elongate member are wound around the first core member.

As such, the elongate graphics displaying member wound around the first core member and the upper and lower elongate members wound around the second core member allow left and right pages to be successively spread to successively present new pages without loosing the pages, as conventional. As such, the book can provide a wonderful impression to the reader and thus attract the attention and interest of the reader.

Furthermore, the upper and lower elongate members vertically sandwiching the elongate graphics displaying member allow left and right pages to reliably, successively rotate and the book to have a level of rigidity required as a book.

Furthermore in the present invention preferably the elongate graphics displaying member has a width larger than a width of the upper and lower elongate members. As such, a large graphical representation can be positioned at the center region of the book to be remarkable.

Furthermore in the present invention preferably the upper and lower elongate members and the elongate graphics displaying member are wound around their respective core members in opposite directions.

As such, the elongate graphics displaying member and the upper and lower elongate members that are wounded are not unintentionally unwound. This ensures that the book has a reliable structure.

Furthermore, the elongate graphics displaying member, positioned at the center region of the book, presents a graphical representation and furthermore the left and right pages spread together present a single graphical representation.

A book conventionally structured has left and right pages bound together in the form of a trough. As such, if the left and right pages together present a single graphical representation the graphical representation cannot have significant impact.

In contrast, the present book can have left and right pages cooperating to provide a complete plane. Thus the left and right pages together can present a single graphical representation to allow the graphical representation to have more impact and thus attract the attention and interest of the reader.

The present invention in another aspect provides a successively developable book including: a first core member provided in a form of a plate and forming a left page; a second core member provided in a form of a plate and forming a right page; a centered elongate member unwound from the first core member as the centered elongate member is wound around the second core member when the left page and the right page are successively rotated and thus spread apart from each other; and an upper elongate member and a lower elongate member provided at upper and lower ends, respectively, of the centered elongate member and unwound from the second core member as the upper elongate member and the lower elongate member are wound around the first core member, wherein the centered elongate member has a width larger than a width of the upper and lower elongate members. As such, the centered elongate member of a large area can be positioned at the center region of the book to be remarkable.

Furthermore, the centered elongate member presents a graphical representation. As such, the graphical representation of a large area can be positioned at the center region of the book to be remarkable.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a perspective view of a successively developable book 100 in one embodiment of the present invention in a “closed position 1”;

FIG. 2 is a perspective view of successively developable book 100 in one embodiment of the present invention in a “spread position 1”;

FIG. 3 is a cross section taken along a line III of FIG. 1, showing an upper elongate member 30 wound, as seen in cross section;

FIG. 4 is a cross section taken along a line IV of FIG. 1, showing elongate graphics displaying member 50 wound, as seen in cross section;

FIG. 5 is a cross section taken along a line V of FIG. 2, showing upper elongate member 30 wound, as seen in cross section;

FIG. 6 is a cross section taken along a line VI of FIG. 2, showing elongate graphics displaying member 50 wound, as seen in cross section;

FIG. 7 is a perspective view of successively developable book 100 in an embodiment of the present invention in a “closed position 2”;

FIG. 8 is a perspective view of successively developable book 100 in an embodiment of the present invention in a “spread position 2”;

FIG. 9 is a cross section taken along a line IX of FIG. 7, showing upper elongate member 30 wound, as seen in cross section;

FIG. 10 is a cross section taken along a line X of FIG. 7, showing elongate graphics displaying member 50 wound, as seen in cross section;

FIG. 11 is a cross section taken along a line XI of FIG. 8, showing upper elongate member 30 wound, as seen in cross section;

FIG. 12 is a cross section taking along a line XII of FIG. 8, showing elongate graphics displaying member 50 wound, as seen in cross section;

FIG. 13 is a perspective view of successively developable book 100 in one embodiment of the present invention in a “closed position 3”;

FIG. 14 is a perspective view of successively developable book 100 in one embodiment of the present invention in a “spread position 3”;

FIG. 15 is a cross section taken along a line XV of FIG. 13, showing upper elongate member 30 wound, as seen in cross section;

FIG. 16 is a cross section taken along a line XVI of FIG. 13, showing elongate graphics displaying member 50 wound, as seen in cross section;

FIG. 17 is a cross section taken along a line XVII of FIG. 14, showing upper elongate member 30 wound, as seen in cross section;

FIG. 18 is a cross section taken along a line XVIII of FIG. 14, showing elongate graphics displaying member 50 wound, as seen in cross section;

FIG. 19 is a perspective view of successively developable book 100 of one embodiment of the present invention in a “closed position 4”;

FIG. 20 is a perspective view of successively developable book 100 of one embodiment of the present invention in a “spread position 4”;

FIG. 21 is a cross section taken along a line XXI of FIG. 19, showing upper elongate member 30 wound, as seen in cross section;

FIG. 22 is a cross section taken along a line XXII of FIG. 19, showing elongate graphics displaying member 50 wound, as seen in cross section;

FIG. 23 is a cross section taken along a line XXIII of FIG. 20, showing upper elongate member 30 wound, as seen in cross section;

FIG. 24 is a cross section taken along a line XXIV of FIG. 20, showing elongate graphics displaying member 50 wound, as seen in cross section;

FIG. 25 is a perspective view of successively developable book 100 in one embodiment of the present invention in a “closed position 5”;

FIG. 26 is a perspective view of successively developable book 100 in one embodiment of the present invention in a “spread position 5”;

FIG. 27 is a cross section taken along a line XXVII of FIG. 25, showing upper elongate member 30 wound, as seen in cross section;

FIG. 28 is a cross section taken along a line XXVIII of FIG. 25, showing elongate graphics displaying member 50 wound, as seen in cross section;

FIG. 29 is a cross section taken along a line XXIX of FIG. 26, showing upper elongate member 30 wound, as seen in cross section; and

FIG. 30 is a cross section taken along a line XXX of FIG. 26, showing elongate graphics displaying member 50 wound, as seen in cross section.

### DESCRIPTION OF THE PREFERRED EMBODIMENTS

Reference will now be made to the figures to describe a successively developable book in an embodiment in accordance with the present invention.

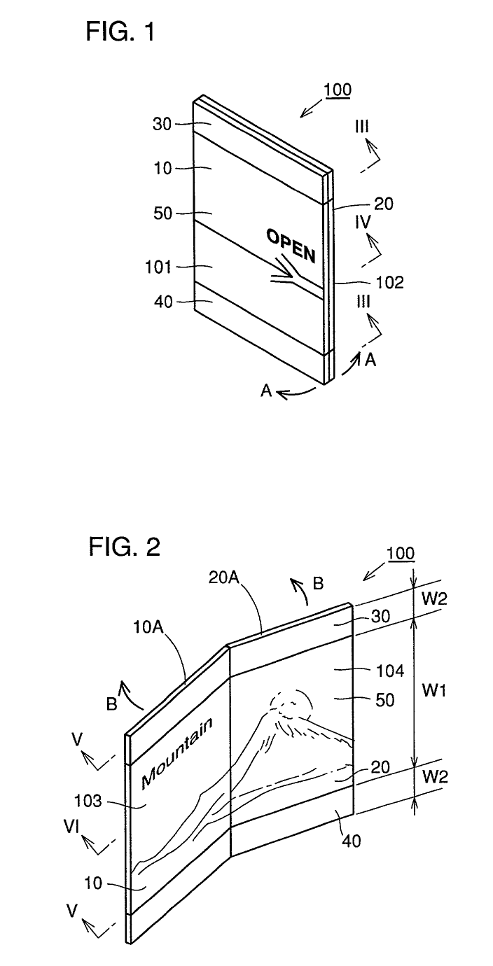

Initially, with reference to FIGS. 1 and 2, the present embodiment provides a successively developable book 100 including a left page 10 and right page 20 having their respective center regions provided with a centered elongate member corresponding to an elongate graphics displaying member 50 presenting a graphical representation. Elongate graphics displaying member 50 has upper and lower ends provided with upper and lower elongate members 30 and 40, respectively.

Elongate graphics displaying member 50 can have a width W1 larger than a width W2 of upper and lower elongate members 30 and 40 to make elongate graphics displaying member 50 more remarkable.

Closed Position 1

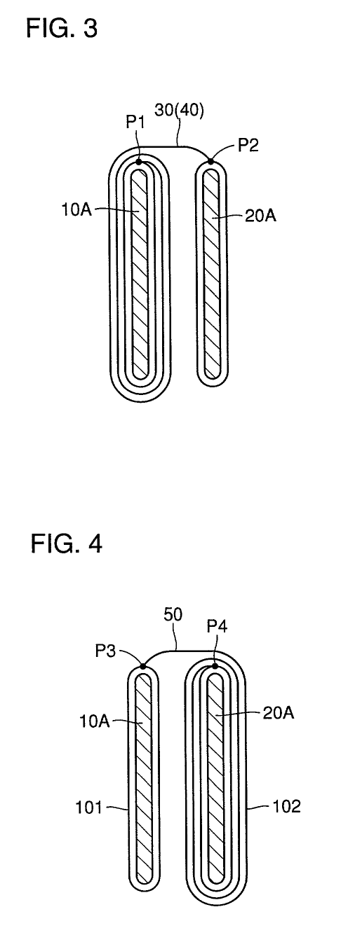

Reference will now be made to FIGS. 3 and 4 to describe upper elongate member 30, elongate graphics displaying member 50 and lower elongate member 40 that are wound. Upper and lower elongate members 30 and 40 are wound in a single manner and lower elongate member 40 will thus not be described.

As shown in FIG. 3, one end P1 is fixed to a core member 10A forming left page 10 and from P1 upper elongate member 30 is wound clockwise, and the other end P2 is fixed to a core member 20A forming right page 20.

Elongate graphics displaying member 50, as shown in FIG. 4, has one end P4 fixed to core member 20A forming right page 20 and from one end P4 elongate graphics displaying member 50 is wound counterclockwise, and the other end P3 is fixed to core member 10A forming left page 10. As such, upper elongate member 30 and elongate graphics displaying member 50 are wound around cores 10A and 20B, respectively, in opposite directions.

Note that the present embodiment provides a single turn of upper elongate member 30 and elongate graphics displaying member 50 around cores 10A and 20A in view of design, which is not a requirement. Lower elongate member 40 is wound in the same manner as upper elongate member 30.

With left and right pages 10 and 20 closed, graphical representations 101 and 102 are exposed outside, as shown in FIGS. 1 and 3.

Spread Position 1

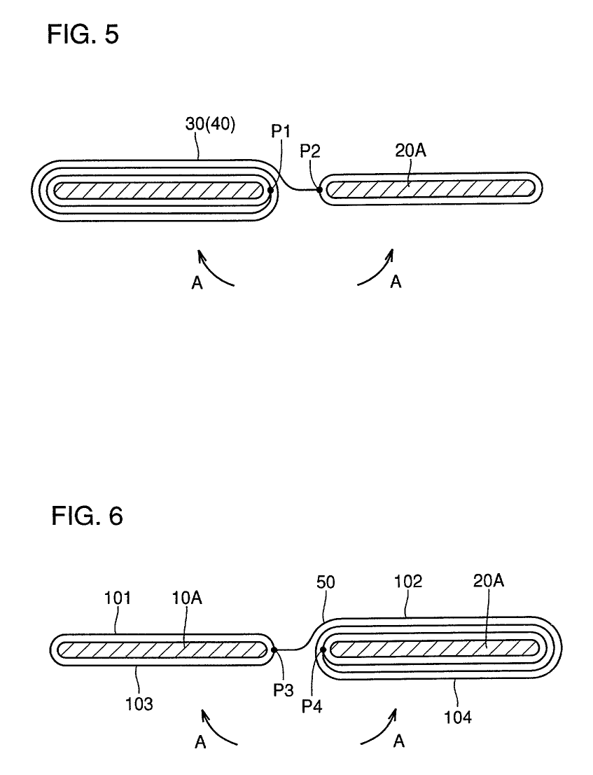

Reference will now be made to FIGS. 2, 5 and 6 to describe left and right pages 10 and 20 spread apart (in the direction of an arrow A of FIGS. 1, 5 and 6).

Upper elongate member 30 has one end P1 and the other end P2 positioned at the center and elongate graphics displaying member 50 has one end P4 and the other end P3 positioned at the center. On left and right pages 10 and 20 graphical representations 103 and 104 appear, respectively, together showing Mt. Fuji, as shown in FIG. 2.

The present embodiment can provide successively developable book 100 having left and right pages 10 and 20 cooperating to provide a complete plane. Thus, left and right pages 20 and 30 together present a graphical representation “Mountain” to allow the graphical representation “Mountain” to have more impact and thus attract more attention and interest of the reader.

Closed Position 2

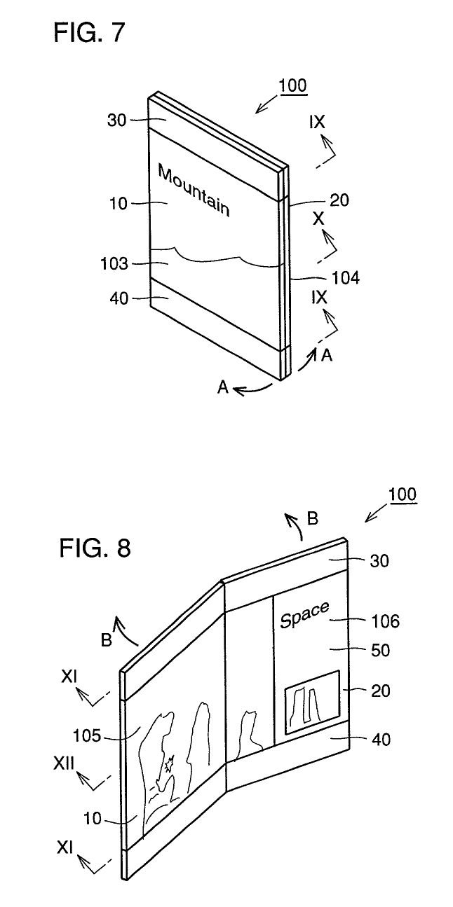

Reference will now be made to FIGS. 7, 9 and 10 to describe left and right pages 10 and 20 further spread apart and thus developed and thus closed. Upper and lower elongate members 30 and 40 are wound in a single manner and lower elongate member 40 will thus not be described.

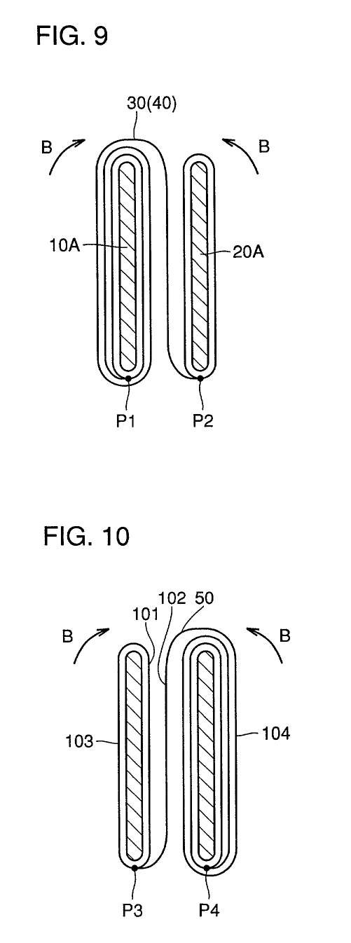

With reference to FIG. 9, upper elongate member 30 has one end P1 rotated clockwise by 90° and the other end P2 rotated counterclockwise by 90°. Similarly, with reference to FIG. 10, elongate graphics displaying member 50 has one end P4 rotated clockwise by 90° and the other end P3 rotated counterclockwise by 90°.

With left and right pages 10 and 20 closed, as shown in FIG. 10, graphical representations 101 and 102 face each other at the center and graphical representations 103 and 104 are exposed outside. Lower elongate member 40 is wound in the same manner as upper elongate member 30.

Spread Position 2

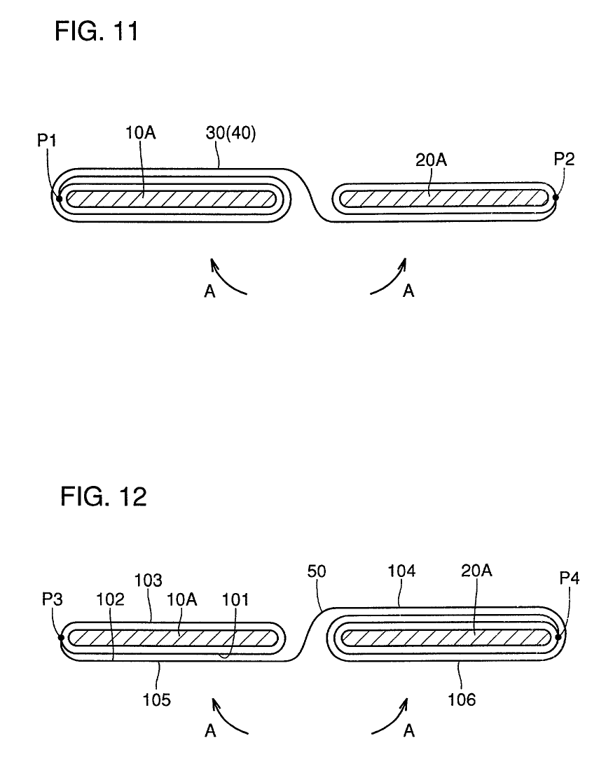

Reference will now be made to FIGS. 8, 11 and 12 to describe left and right pages 10 and 20 further spread (in the direction of arrow A of FIGS. 7, 11 and 12).

Upper elongate member 30 has one end P1 and the other end P2 positioned outside and elongate graphics displaying member 50 has one end P4 and the other end P3 positioned outside. As upper elongate member 30 is wound around a second core member 20A it is unwound from a first core member 10A. Furthermore, as lower elongate member 40 is wound around the first core member 10A it is unwound from a second core member 20A.

Consequently, on left and right pages 10 and 20 graphical representations 105 and 106 appear, respectively, together presenting a graphical representation “Space”, as shown in FIG. 8.

The present embodiment can provide successively developable book 100 having left and right pages 10 and 20 cooperating to provide a complete plane, as shown in FIGS. 8 and 12. Thus, left and right pages 10 and 20 together can present the graphical representation “Space” to allow the graphical representation to have more impact and thus attract more attention and interest of the reader.

Closed Position 3

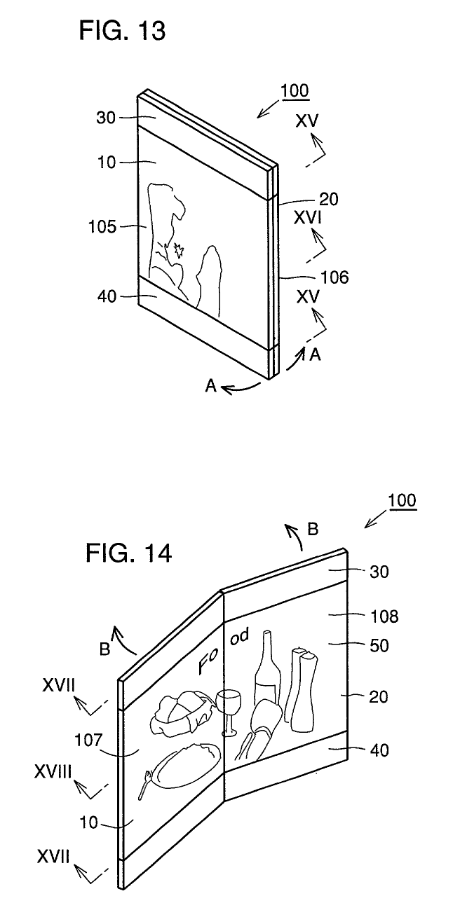

Reference will now be made to FIGS. 13, 15 and 16 to describe left and right pages 10 and 20 further spread and thus developed (in the direction of arrow B of FIGS. 8, 15 and 16) and thus closed. Upper and lower elongate members 30 and 40 are wound in a single manner and lower elongate member 40 will thus not be described.

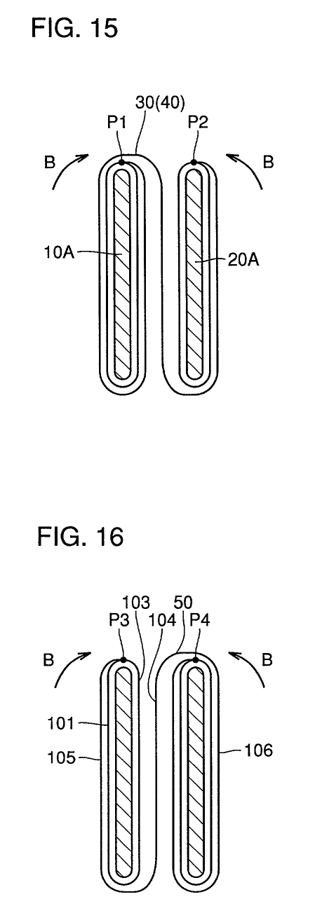

As shown in FIG. 15, upper elongate member 30 has one end P1 rotated clockwise by 90° and the other end P2 rotated counterclockwise by 90°. Similarly, with reference to FIG. 16, elongate graphics displaying member 50 has one end P4 rotated clockwise by 90° and the other end P3 rotated counterclockwise by 90°.

With left and right pages 10 and 20 closed, as shown in FIG. 16, graphical representations 103 and 104 face each other at the center and graphical representations 105 and 106 are exposed outside. Lower elongate member 40 is wound in the same manner as upper elongate member 30.

Spread Position 3

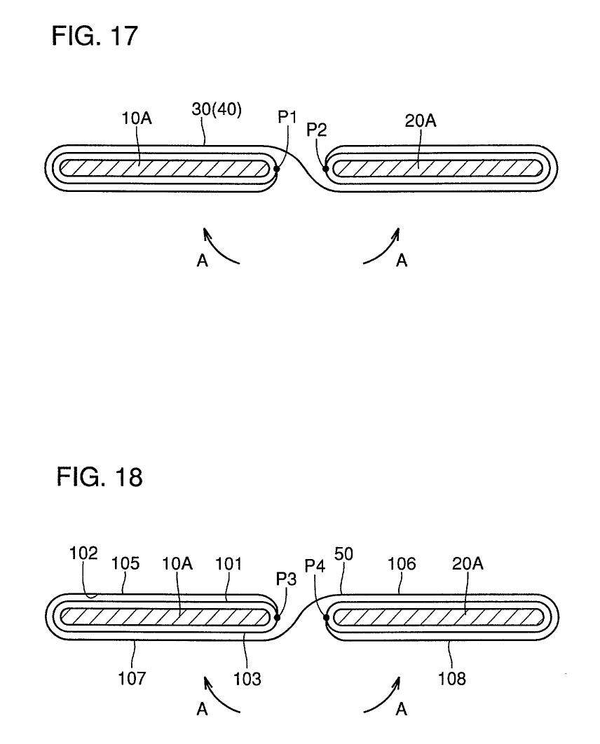

Reference will now be made to FIGS. 14, 17 and 18 to describe left and right pages 10 and 20 further spread (in the direction of arrow A of FIGS. 13, 17 and 18).

Upper elongate member 30 has one end P1 and the other end P2 positioned closer to the center and elongate graphics displaying member 50 has one end P4 and the other end P3 positioned closer to the center. As upper elongate member 30 is wound around the second core member 20A it is unwound from the first core member 10A. Furthermore, as lower elongate member 40 is wound around the first core member 10A it is unwound from the second core member 20A.

Consequently, on left and right pages 10 and 20 graphical representations 107 and 108 appear, respectively, together presenting a graphical representation “Food”, as shown in FIG. 14.

The present embodiment can provide successively developable book 100 having left and right pages 10 an 20 cooperating to provide a complete plane, as shown in FIGS. 14 and 18. Thus, left and right pages 10 and 20 together can present a graphical representation “Food” to allow the graphical representation to have more impact and thus attract more attention and interest of the reader.

Closed Position 4

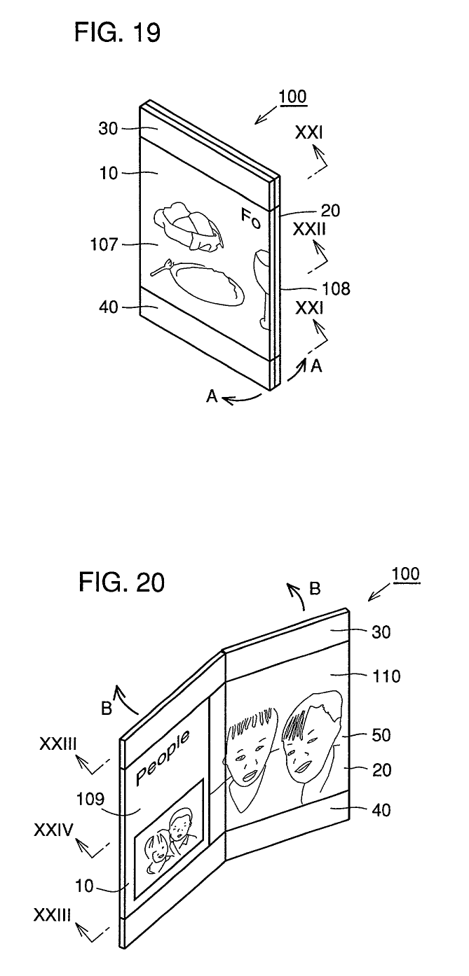

Reference will now be made to FIGS. 19, 21 and 22 to describe left and right pages 10 and 20 further spread and thus developed (in the direction of arrow B of FIGS. 14, 21 and 22) and thus closed. Upper and lower elongate members 30 and 40 are wound in a single manner and lower elongate member 40 will thus not be described.

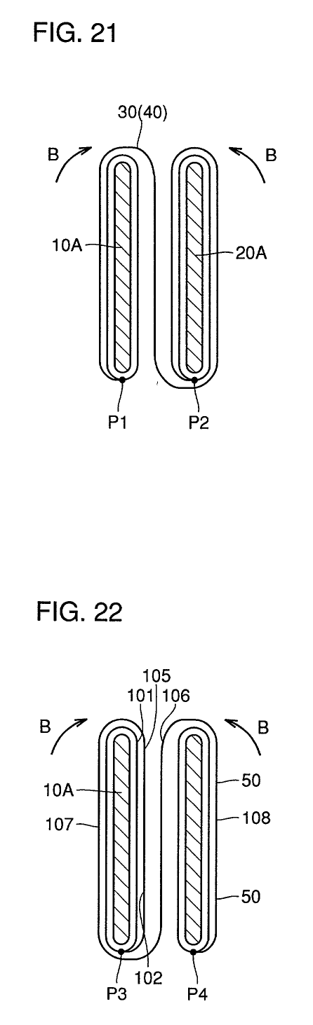

With reference to FIG. 21, upper elongate member 30 has one end P1 rotated clockwise by 90° and the other end P2 rotated counterclockwise by 90°. Similarly, with reference to FIG. 22, elongate graphics displaying member 50 has one end P4 rotated clockwise by 90° and the other end P3 rotated counterclockwise by 90°.

With left and right pages 10 and 20 closed, as shown in FIG. 22, graphical representations 105 and 106 face each other at the center and graphical representations 107 and 108 are exposed outside. Lower elongate member 40 is wound in the same manner as upper elongate member 30.

Spread Position 4

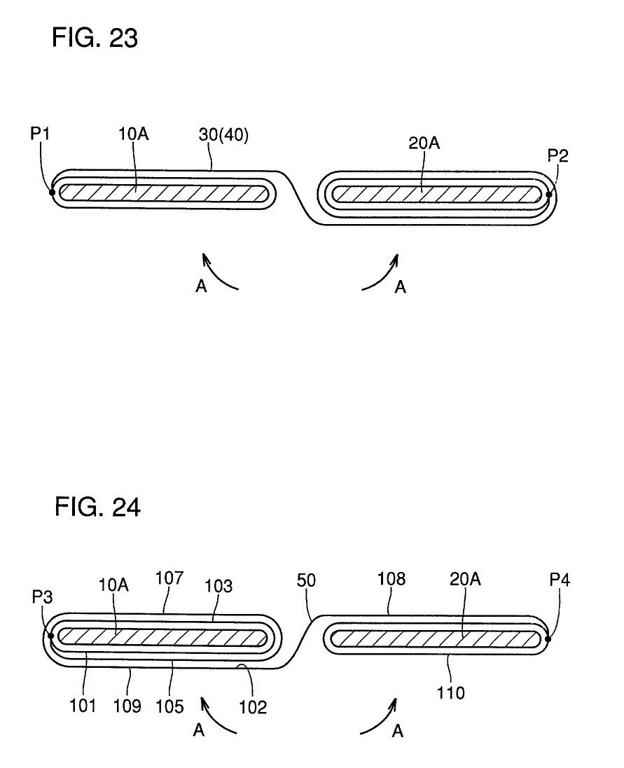

Reference will now be made to FIGS. 20, 23 and 24 to describe left and right pages 10 and 20 further spread (in the direction of arrow A of FIGS. 19, 23 and 24).

Upper elongate member 30 has one end P1 and the other end P2 positioned outside and elongate graphics displaying member 50 has one end P4 and the other end P3 positioned outside. As upper elongate member 30 is wound around the second core member 20A it is unwound from the first core member 10A. Furthermore, as lower elongate member 40 is wound around the first core member 10A it is unwound from the second core member 20A.

Consequently, on left and right pages 10 and 20 graphical representations 109 and 110 appear, respectively, together presenting a graphical representation “People”, as shown in FIG. 20.

The present embodiment can provide successively developable book 100 having left and right pages 10 and 20 cooperating to provide a complete plane, as shown in FIGS. 20 and 24. Thus, left and right pages 10 and 20 together can present a graphical representation “People” to allow the graphical representation to have more impact and thus attract more attention and interest of the reader.

Closed Position 5

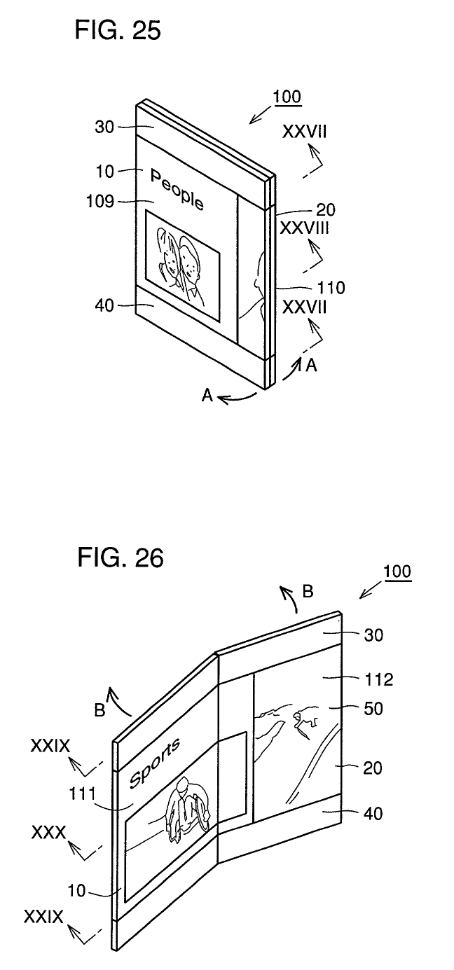

Reference will now be made to FIGS. 25, 27 and 28 to describe left and right pages 10 and 20 further spread and thus developed (in the direction of arrow B of FIGS. 20, 27 and 28) and thus closed. Upper and lower elongate members 30 and 40 are wound in a single manner and lower elongate member 40 will thus not be described.

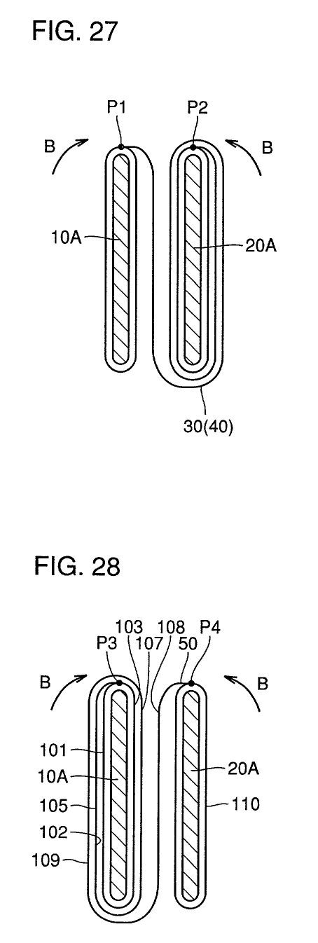

As shown in FIG. 27, upper elongate member 30 has one end P1 rotated clockwise by 90° and the other end P2 rotated counterclockwise by 90°. Similarly, with reference to FIG. 28, elongate graphics displaying member 50 has one end P4 rotated clockwise by 90° and the other end P3 rotated counterclockwise by 90°.

With left and right pages 10 and 20 closed, as shown in FIG. 28, graphical representations 107 and 108 face each other at the center and graphical representations 109 and 110 are exposed outside. Lower elongate member 40 is wound in the same manner as upper elongate member 30.

Spread Position 5

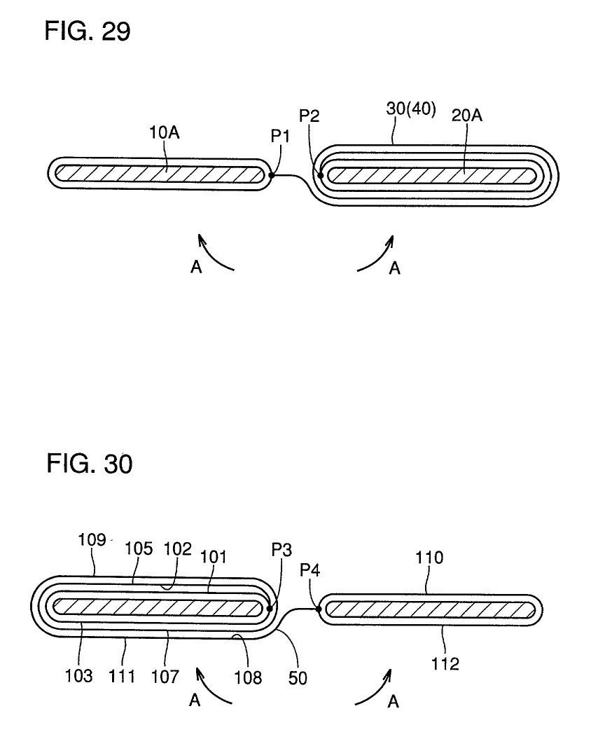

Reference will now be made to FIGS. 26, 29 and 30 to describe left and right pages 10 and 20 further spread (in the direction of arrow A of FIGS. 25, 29 and 30).

Upper elongate member 30 has one end P1 and the other end P2 positioned closer to the center and elongate graphics displaying member 50 has one end P4 and the other end P3 positioned closer to the center. As upper elongate member 30 is wound around the second core member 20A it is unwound from the first core member 10A. Furthermore, as lower elongate member 40 is wound around the first core member 10A it is unwound from the second core member 20A.

Consequently, on left and right pages 10 and 20 graphical representations 111 and 112 appear, respectively, together presenting a graphical representation “Sports”, as shown in FIG. 26.

The present embodiment can provide successively developable book 100 having left and right pages 10 and 20 cooperating to provide a complete plane, as shown in FIGS. 26 and 30. Thus, left and right pages 10 and 20 together can present a graphical representation “Sports” to allow the graphical representation to have more impact and thus attract more attention and interest of the reader.

Thus the present embodiment can provide successively developable book 100 including upper and lower elongate members 30 and 40 wound around the second core member 20A and elongate graphics displaying member 50 positioned at the center region, having a width larger than upper and lower elongate members 30 and 40 and wound around the first core member 10A to allow left and right pages 10 and 20 to be successively spread apart to successively present new pages without loosing the pages, as conventional. As such, the book can provide a wonderful impression to the reader and thus attract the attention and interest of the reader.

Furthermore, upper and lower elongate members 30 and 40 vertically sandwiching elongate graphics displaying member 50 allow left and right pages 10 and 20 to reliably, successively rotate and the book to have a level of rigidity required as a book. It should be noted that at least one elongate member having a function equivalent to that of the upper elongate member and at least one elongate member having a function equivalent to that of the elongate graphics displaying member, suffice to successively rotate left and right pages and any number of the upper and lower elongate members and the elongate graphics displaying member may be selected, as appropriate, when the book is designed.

As has been described above, upper and lower elongate members 30 and 40 and elongate graphics displaying member 50 are wound around the first and second core members 10A and 20A, respectively, in opposite directions. As such, upper elongate member 30, elongate graphics displaying member 50 and lower elongate member 40 that are wounded are not unintentionally unwound. This ensures that the book has a reliable structure.

Note that upper elongate member 30, elongate graphics displaying member 50 and lower elongate member 40 may have any number of turns around their respective core members that is not limited to the present embodiment and can thus be selected as appropriate. Furthermore, the number of turns around the first core member 10a and that of turns around the second core member 20A may or may not be the same, although the book has a development count corresponding to the smaller turn count.

Furthermore, elongate graphics displaying member 50 with left and right pages 10 and 20 spread, presents a single graphical representation on a complete plane provided by left and right pages 10 and 20. Consequently, the graphical representation can have more impact and attract more attention and interest of the reader.

While as a most preferably example left and right pages 10 and 20 together provide a single graphical representation, left and right pages 10 and 20 may present independent graphical representations, respectively.

Furthermore, book 100 that is spread can also have a back side with elongate graphics displaying member 50 positioned thereon. As such, elongate graphics displaying member 50 can bear a graphical representation selected to consider not only the front side but also the back side.

It should be noted that in the present embodiment the “graphical representation” includes not only pictures, patterns and characters but also photographs, pattern-free, mono-color representations and also a display device employing an electrical means such as liquid crystal, and the like.

The successively developable book thus structured is applicable to not only picture books, restaurant menus, car catalogues and company advertisement brochures that are provided in a form of book but also accommodating credit cards, FDs, CDs, MDs, MOs, CDROMs and the like, magic and other various applications.

The present invention can provide a successively developable book including an elongate graphics displaying member wound around a first core and upper and lower elongate members wound around a second core member to allow left and right pages to be successively spread to present new pages successively on the elongate graphics displaying member without loosing the pages, as conventional. As such, the book can provide a wonderful impression to the reader and thus attract the attention and interest of the reader.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A successively developable book presenting a different graphical representation for each spread page, comprising:
a first core member provided in a form of a plate and forming a left page;
a second core member provided in a form of a plate and forming a right page;
an elongate graphics displaying member located at a center region of the book and presenting a graphical representation, unwound from said first core member as said elongate graphics displaying member is wound around said second core member when said left page and said right page are successively rotated and thus spread apart from each other; and
an upper elongate member and a lower elongate member provided at upper and lower ends, respectively, of said elongate graphics displaying member and unwound from said second core member as said upper elongate member and said lower elongate member are wound around said first core member.

2. The successively developable book of claim 1, wherein said elongate graphics displaying member has a width larger than a width of said upper and lower elongate members.

3. The successively developable book of claim 1, wherein said upper and lower elongate members and said elongate graphics displaying member are wound around their respective, said core members in opposite directions.

4. The successively developable book of claim 3, wherein said left and right pages spread cooperate to present a single graphical representation.

5. A successively developable book comprising:
a first core member provided in a form of a plate and forming a left page;
a second core member provided in a form of a plate and forming a right page;
a centered elongate member unwound from said first core member as said centered elongate member is wound around said second core member when said left page and said right page are successively rotated and thus spread apart from each other; and
an upper elongate member and a lower elongate member provided at upper and lower ends, respectively, of said centered elongate member and unwound from said second core member as said upper elongate member and said lower elongate member are wound around said first core member,
wherein said centered elongate member has a width larger than a width of said upper and lower elongate members.

6. The successively developable book of claim 5, wherein said centered elongate member presents a graphical representation.
